(19) United States
(12) Patent Application Publication
(10) Pub. No.: US 2024/0243298 A1
(43) Pub. Date: Jul. 18, 2024

(54) THERMOPLASTIC BASED COMPOSITE MATERIALS USED FOR ANODES IN SECONDARY BATTERIES

(71) Applicant: Izmir Egitim Saglik Sanayi Yatirim A.S., Bornova (TR)

(72) Inventors: Akin ISBILIR, Manisa (TR); Berkay Metin Leskeri, Bornova (TR); Emre Can Bagcivan, Bornova (TR); Mehmet Sarikanat, Bornova (TR); Zekerya Dursun, Bornova (TR)

(21) Appl. No.: 18/568,803

(22) PCT Filed: Jun. 10, 2021
(86) PCT No.: PCT/TR2021/050569

§ 371 Date: Dec. 9, 2023

(51) Int. Cl. H01M 4/66; H01M 4/02; H01M 4/04; H01M 4/13; H01M 4/139

(52) U.S. Cl. CPC H01M 4/668; H01M 4/0404; H01M 4/043; H01M 4/13; H01M 4/139; H01M 4/661; H01M 4/667; H01M 2004/027

(57) ABSTRACT

A reinforcement and/or filling material is added to conventionally insulating thermoplastic material in order to endow it with electrical conductivity and make it suitable for anode material in secondary batteries. This way it is made possible to use thermoplastic composite material endowed with electrical conductivity and energy storage properties as an alternative to the graphite conventionally used on the copper sheet as lithium contact in the anode cell.

### TECHNICAL FIELD

A reinforcement and/or filling material is added to thermoplastic resin which is intended for use on anode elements of secondary batteries in order to make the electrically insulating thermoplastics into a conducting material and endowed it with energy storage property. This way it is made possible use thermoplastic based composite endowed with electrical conductivity and energy storage properties as an alternative to the graphite conventionally used on the copper plate as lithium host in the anode cell.

### PREVIOUS ART

One of the most important problems of our age is to lower costs in generation and storage of energy. As some of the most well founded branches of fundamental sciences, electrochemical studies, and material science carry great importance in discovery and development of clean and renewable energy sources. The demand for energy storage devices grow every passing day in proportion to renewable energy sources which prove to be unstable. As a general reference, systems used in energy storage which convert chemical energy into electrical energy are called as batteries.

Types of batteries widely used today include primary batteries and secondary batteries. Primary batteries are non-chargeable batteries, while secondary batteries are chargeable type. Secondary batteries are more widely used due to being re-useable and more suitable for environmentally-friendly sensibilities. Having become popular in recent years, secondary batteries, especially lithium ion (Li-ion) batteries are subject to increasing numbers of research and development projects. In recent years, there have been intensive studies on development of new generation composite anode and cathode electrodes with low cost and high efficiency.

Requirements, in communications to defence industry, medicine, transport and many more fields are rapidly met with the developments and goals in technology.

In the 21^{st} century, mobile electronic devices (cell phones, cameras, computers, etc.) have a significant effect on our daily life. Furthermore, most electronic devices we daily-drive have become compatible with wireless use in-line with technological developments. The foremost condition for use of such wireless devices is having a mobile energy source. This energy source must have a high energy density, long useful life, and short charge time as well as being environmentally harmless. In this context, rechargeable secondary batteries are widely used to supply energy in electronic device technologies. Many studies argue that as petroleum resources are exhausted, use of electrical vehicles will increase and this arising energy storage need will be met by new generation secondary batteries.

The most popular type of batteries used today are Li-ion batteries. Li-ion batteries comprise a lithium source (lithium metal, lithium salt or organo-lithium compounds) as a cathode material, carbon-based compounds, ceramics or metallic salts as a host anode material, and a non-aqueous organic solution or a solid phase electrolyte as the electrolyte material.

In the current state of the art, instability of the graphite, generation of lithium dendrites, problems in cycle number, inefficiency in energy capacity, lower energy density, difficulty of production, safety problems and environmental hazard posed by limited recyclability constitute barriers against spread of secondary batteries.

Solutions in the current state of the art generally trend towards materials like carbon-based composites, polymeric composites, ceramic composites, metallic composites having electrically conductive properties. In the current state of the art an article published on Volume 135 of the Journal of Power Sources in September 2004 under the title of “Pyrolysis of an alkyltin/polymer mixture to form a tin/carbon composite for use as an anode in lithium-ion batteries” mentions polymeric materials with known electrical conductivity. While anode materials studied in this context provide the desired discharge capacity, energy density and cycle number gains, difficulty of production, and production line (or production process) costs have led to problems in launching such products.

As synthetic or natural implementation of the conventionally used graphite material poses various difficulties, processing of this material for use as an anode requires large amounts of effort and cost.

Furthermore, an article published in Volume 152 of the Mechanics of Materials journal in January 2021 under the title of “Modelling electrolyte-immersed tensile property of polypropylene separator for lithium-ion battery” covers production of electrolytes. The said work covers studies generally using thermoplastics, particularly polypropylene (PP) and polyethylene (PE) in production of electrolytes. Literature also includes studies where thermoplastics are generally utilised for thermal energy storage purposes. For example, an article published on Volume 15 of the Materials Today Communications journal in June 2018 under the title of “3D printable thermoplastic polyurethane blends with thermal energy storage/release capabilities mentions thermal storage elements made of thermoplastics”. However, it is seen that thermoplastic composite materials were not used for electrical energy storage.

### PURPOSE OF THE INVENTION

Thermoplastics have become one of the most widely used materials in the modern life in recent years due to their superior mechanical properties, thermal stability, ease of processing and recyclability.

Thermoplastics constitute a polymer class which can be softened and melted by application of heat and processed in their heat softened form (e.g. thermal forming) or in their melted form (e.g. extrusion and injection moulding). Thermoplastic polymers can be reprocessed again and again by heat treatment and can be recycled to produce new products. The most widespread production processes used to produce thermoplastic pieces include injection moulding, inflation and heat forming.

In addition to their recycling advantage, thermoplastics also have high flexibility and impact resistance. They can also be combined together using various welding techniques like resistance welding, vibration welding and ultrasonic welding. Furthermore, shaping times of thermoplastic pieces are also quite low.

While thermoplastics are widely processed and utilised across the world, it is ascertained that they have not been tested as anode material in secondary batteries. It is contemplated thermoplastics would prove a good host for lithium ions due to their molecular structure (long chain structures) and prove to be an anode material with high charge-discharge capacity.

Production of thermoplastic based composite materials can be easily achieved by compounding with twin-screw extruder. Compared to the anode production method in the current state of the art, compounding is both more practical and faster. In addition, being easier to form, thermoplastics open the door to faster, more varied and easier methods for processing after being produced as anode materials.

The purposes in using thermoplastic based composite materials as anode material of secondary batteries are as listed below:
To provide an increase in discharge capacity, energy capacity and cycle number of the anode;
To ensure standardisation and facilitation of the anode production process and to lower production costs; and
To prevent known safety problems with lithium ion batteries (explosion, heating, ignition, etc.) and to ensure anode material can be recycled by using thermoplastic based composite materials in anode production.

### DETAILED DESCRIPTION OF THE INVENTION

### Description of the Images

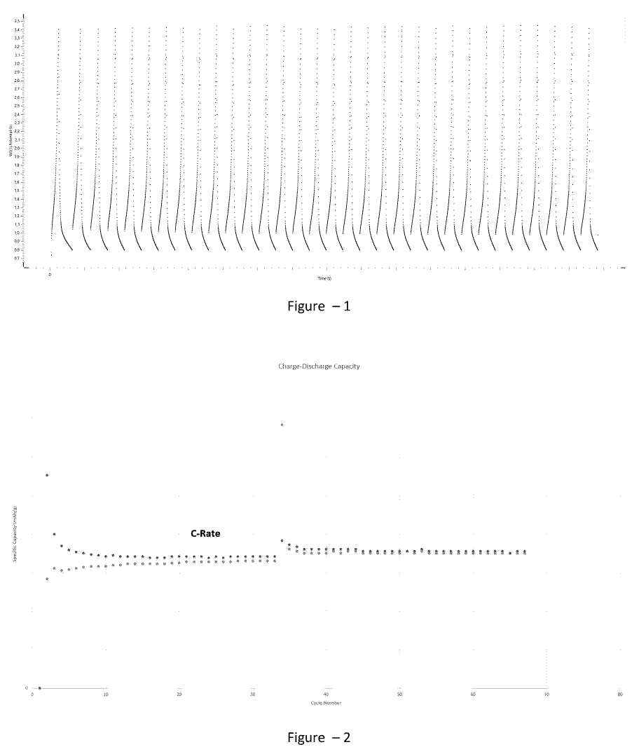

FIG. 1 Potential against time curve

FIG. 2 Specific capacity against cycle number curve

The largest reason for thermoplastics not being able serve as an anode material on their own is the fact that thermoplastics are electrically insulating materials due to their nature. In studies in this context thermoplastic based composite materials are developed in order to provide thermoplastic parts which are electrically conductive and suitable for energy storage. In scope of these studies, it is discovered that combination of thermoplastic materials with metals and/or metal salts, and/or organo-metallic compounds and/or carbon derivative reinforcement and/or filling materials improve their conductivity, energy storage and stability properties.

Thermoplastic based composite materials endowed with electrical conductivity and energy storage properties are used as anode materials in secondary batteries. This way, the cycle number of the battery and its suitability for recycling are improved. Use of thermoplastic based composite materials as an anode material and decrease of the density of the anode material allows an increase in useable amount of active material. In result of this, charge-discharge capacity is increased and formation of lithium dendrites is prevented in the utilised reinforcement and/or filling materials.

Polymer based composite materials utilise at least one of the following materials as the thermoplastic matrix: Polyethylene (PE), Polypropylene (PP), Polystyrene (PS), Polyethylene terephthalate (PET or PTFE), Polyamide (PA) (Nylon), Polyvinyl chloride (PVC), Polycarbonate (PC), Acrylonitrile butadiene styrene (ABS), Polyvinylidene chloride (PVDC), Polybutylene Terephthalate (PBT), Polyphenylene Sulphide (PPS), Syndiotactic Polystyrene (SPS), Polyether ether ketone (PEEK), Polyketones (POK). In order to endow electrical conductivity property to polymers which are naturally electrical insulators a thermoplastic based composite material formula is created by adding metal, metal salts and organo-metallic compounds, as well as carbon derivatives (graphite, graphene, carbon nanotubes, carbon fibres, etc.). Twin screw extruders are used in production of thermoplastic based composite materials.

During production of thermoplastic composite materials using twin screw extruders, metals and/or metal salts, organo-metallic compounds and carbon derivatives and primary and secondary antioxidants are added into the melted thermoplastic matrix. This melted material is passed through the mould in front of the extruder and cut by help of the pelletizer to obtain granules.

Main mechanism used in an extrusion operation include feeding, melting and homogenous mixing. L/D ratio of the extruder has an effect on mixing and homogeneity of the output. Material output speed of the extruder depends on the screw revolution rate, barrel temperature, screw configuration, and viscosity of the material.

According to these parameters 30% to 80% thermoplastic material is used in thermoplastic based composite materials produced by compounding method. 3% to 30% metal and/or metal salts and organo-metallic compounds and 20% to 60% carbon derivative materials are used as reinforcement and/or filling materials.

Primarily, granulated thermoplastic based composite materials are ground down to a particle size under 200 μm.

According to the type of the utilised thermoplastic material, the material should be homogenously laid on a copper sheet or made to adhere strongly to the plate either only using a binding agent or also utilising additional chemicals.

The process steps for use of a thermoplastic based composite material as anode material in Li-ion type secondary batteries are detailed below;
The thermoplastic based composite material is applied on the copper sheet by mechanical and/or chemical surface processes to ensure adhesion of the material on the copper sheet.
In the process performed according to the type of thermoplastic material, a sufficient amount of non-aqueous organic binder is homogenised with the thermoplastic based composite material in an automatic mill and this preparation is applied on the copper sheet.
In case of materials for which binder is not sufficient on its own, 85% thermoplastic based composite material, 10% to 20% binder or conductivity enhancer and stability improving materials are added together according to the type of thermoplastic material, and homogenised with the thermoplastic based composite material in an automatic mill. The thermoplastic based composite material produced by this process is then applied on the copper sheet.
The anode material processed in this fashion is then formed according the desired type of battery and made ready for battery production process.

Secondly, the material produced and granulated in the extruder was formed into a thin film. The thin film material is applied to the copper sheet with the hot press and/or lamination process with a binder additive, turned into an anode and is ready for the battery production process.
Prototype anode material trial processes are tested according to half-cell button battery procedure. The produced anode material is applied on the copper sheet and dried. After drying process, the created electrodes are pressed. The prepared anodes are left to wait in inert argon atmosphere before being placed in the half-cells. This process is the most important stage for removal of water and oxygen in the produced anode material. After this, the anode material purged of water and oxygen content is coated to create the half-cell button battery. The prototype battery produced in these studies is a CR20XX type battery.

Various R&D tests were conducted on the created CR20XX type battery. Potentiostat is an electronic device used to check the potential difference between the Operating Electrode and Reference Electrode found in the electrochemical cell. Potentiostat performs this check by sending a current into the cell across the electrodes. Cyclic voltammetry, a voltammetry technique, discharge capacity measurements, cycle number tests and impedance measurements were performed using the potentiostat device. (Image-1 and Image-2)

The thermoplastic based composite material developed as detailed above can also be used in various types of batteries in any field of application (automotive, industry, satellites, etc.).

1. An anode intended for use in secondary batteries, characterised by;
a. A composite material comprised of 30% to 80% thermoplastic material, 3% to 30% metal and/or metal salts and/or organometallic compounds and/or 20% to 60% carbon derivatives; and
b. A copper derivative sheet on which the said composite material is applied before pressing the piece.

2. A production method for an anode intended for use in secondary batteries, characterised by the process steps including;
a. Application of mechanical and/or chemical surface processes on the said copper derivative collector to ensure adhesion of the said composite material on the said copper derivative collector;
b. According to type of the thermoplastic, only a sufficient amount of non-aqueous organic binder being homogenised with the composite material in an automatic mill and this preparation being applied on the copper derivative collector;
c. According to type of the thermoplastic, where binder is not sufficient on its own, additional composite material, binder or conductivity enhancer and stability enhancer materials being added together with a non-aqueous organic binder, the mixture being homogenised with the composite material in an automatic mill and this preparation being applied on the copper derivative collector;
d. This processed anode material being formed according to the battery type and being made ready for battery production process;
e. Secondly, the material produced and granulated in the extruder was formed into a thin film. The thin film material is applied to the copper plate with the hot press and/or lamination process with a binder additive, turned into an anode and is ready for the battery production process;
f. Application of the said anode material on the copper derivative collector and drying of the said material;
g. After drying is completed, the created electrodes being pressed;
h. Prepared anodes being left in an inert argon atmosphere to remove water and oxygen content before being place in the half-cells; and
i. Applying battery coating process on the anode material to create the half-cell battery.
